(19) United States
(12) Patent Application Publication
(10) Pub. No.: US 2011/0062805 A1
(43) Pub. Date: Mar. 17, 2011

(54) SWITCHED RELUCTANCE MACHINE WITH EDDY CURRENT LOSS DAMPENER

(75) Inventor: Satish D. Savant, Peoria, IL (US)

(73) Assignee: Caterpillar Inc., Peoria, IL (US)

(21) Appl. No.: 12/561,625

(22) Filed: Sep. 17, 2009

(51) Int. Cl. H02K 37/22

(52) U.S. Cl. 310/48

(57) ABSTRACT

A variable reluctance machine is disclosed, such as a switched reluctance machine, the machine having a rotor, a stator, a housing, and a magnetic eddy current dampening component disposed between stator and housing. The magnetic eddy current dampening component not only reduces the eddy current's impact on surrounding electronics, it also assists in increasing the efficiency of the switched reluctance machine.

### TECHNICAL FIELD

The present invention relates generally to variable reluctance machines. More particularly, the present invention relates to a type of variable reluctance machine known as a switched reluctance machine and to a component for dampening magnetic eddy currents therein.

### BACKGROUND

A switched reluctance machine (motor or generator) is a form of variable reluctance machine. A switched reluctance motor generates torque by exploiting magnetic attraction created between the magnetic poles of the rotor and the stator by energizing the coils. FIG. 1 shows a typical switched reluctance drive in schematic form, where the switched reluctance machine 12 having phase windings 16 is connected to a load 19. Other components of a typical system may include a power supply 11, a power converter 13, and an electronic control unit 14.

Such variable reluctance machines are generally constructed from laminations of electrical sheet steel, the resulting structure being used to carry the magnetic flux on which the machine depends for its operation. The structure is laminated to reduce the effect of eddy currents that flow in the steel due to the time rate of change of the flux.

A cross-section of a typical switched reluctance machine is shown in FIGS. 2 and 3. The machine is doubly salient, i.e. both stator and rotor laminations have magnetically salient poles. In FIG. 2 the rotor is shown with a pair of poles fully aligned with the stator poles of Phase A. This represents the position of maximum inductance of the phase. In FIG. 3 the rotor has been rotated to the position where an inter-polar axis of the rotor is aligned with the stator poles. This represents the position of minimum inductance. As the rotor rotates, the inductance varies between the extremes of the maximum and minimum inductance. Typically, the rotor and the stator have the same axial length and the flux paths within them are notionally the same at any cross-section along that axial length. The axial lengths of the cores are often denoted as the “active length” of the machine, the end-turns of the windings lying outside the active length at both ends of the machine.

A schematic flux path is shown in dashed lines on FIGS. 2 and 3 and, while this considerably simplifies the complexity of the actual paths, it illustrates that the flux passes through the back-iron of the stator as well as through the stator poles, i.e. the back-iron region of the stator is an integral part of the magnetic circuit associated with the phase winding. It will also be clear from FIG. 3 that the minimum inductance is heavily dependent on the length of the air path from the stator poles to the rotor back iron. Finally, FIG. 4 illustrates a longitudinal cross-section of a switched reluctance machine known in the art.

These paths of magnetic flux may extend beyond the electrical machine itself and have negative consequences, including interference with nearby electronic circuits and loss of efficiency of the electrical machine. Magnetic shielding protects electronic circuits from magnetic field interference. Usually, sources of this interference include permanent magnets, transformers, motors, solenoids, and cables. Magnetic shields provide a path around sensitive areas to deflect magnetic flux. In addition, shielding may contain magnetic flux around a component that generates flux, thereby increasing the efficiency of the component. Three types of materials are used for magnetic shielding—high permeability, medium permeability, and high saturation.

One approach of reducing eddy currents is not to use a shield at all; rather, Deodhar et al. (U.S. Pat. App. No. 2007/0029890) suggest removing material from the stator housing to reduce the eddy current presence outside of the variable reluctance machine. However, this approach hinges on the reduction in eddy current by removing the amount of housing material, which may be either non-magnetic or magnetic material.

### SUMMARY OF THE INVENTION

In one aspect, the present disclosure is directed to a magnetic eddy current dampening component for switched reluctance machines. The magnetic eddy current dampening component comprises a generally cylindrical main body having an inner surface, an outer surface, and a wall thickness between the inner surface and the outer surface. The main body comprises a material having relative magnetic permeability of less than about 5 and a coefficient of thermal expansion at room temperature of between about 1.00×10⁻⁵/° C. and about 2.50×10⁻⁵/° C.

In another aspect, the present disclosure is directed to a switched reluctance machine comprising a rotor, stator, housing, and a magnetic eddy current dampening component as described above.

### BRIEF DESCRIPTION OF THE DRAWINGS

FIG. 1 is a schematic of a switched reluctance system.

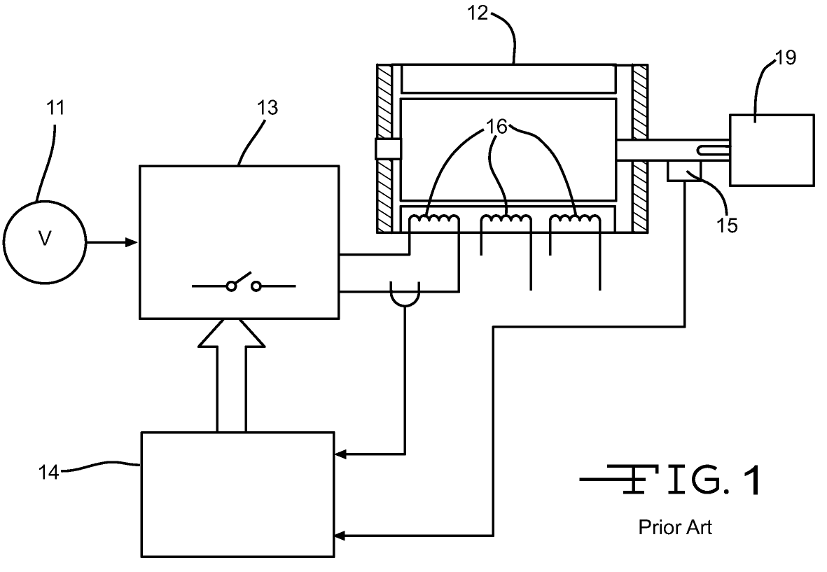

FIG. 2 is a cross-sectional view of a variable reluctance machine in the aligned position.

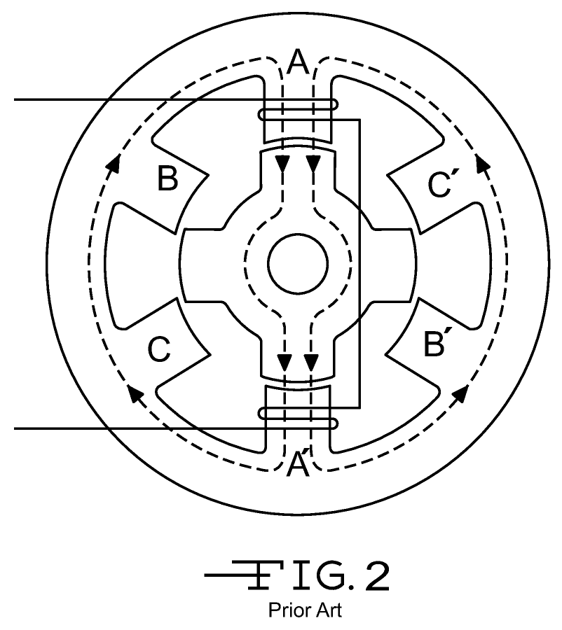

FIG. 3 is a cross-sectional view of a variable reluctance machine in the unaligned position.

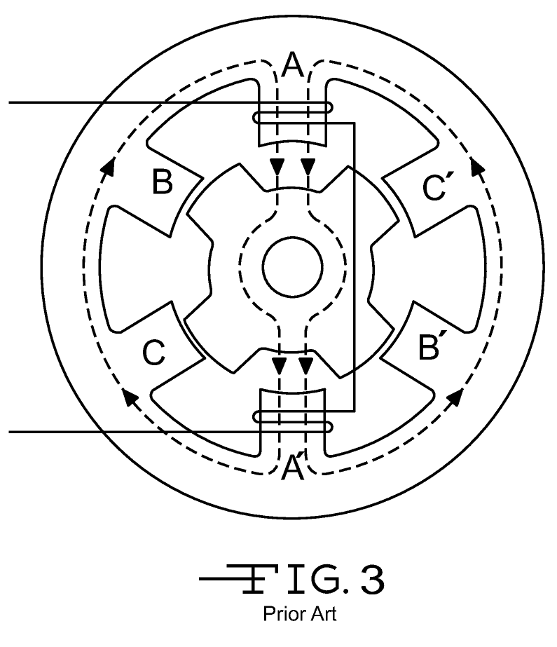

FIG. 4 is a cross-sectional side perspective view of a switched reluctance machine known in the art.

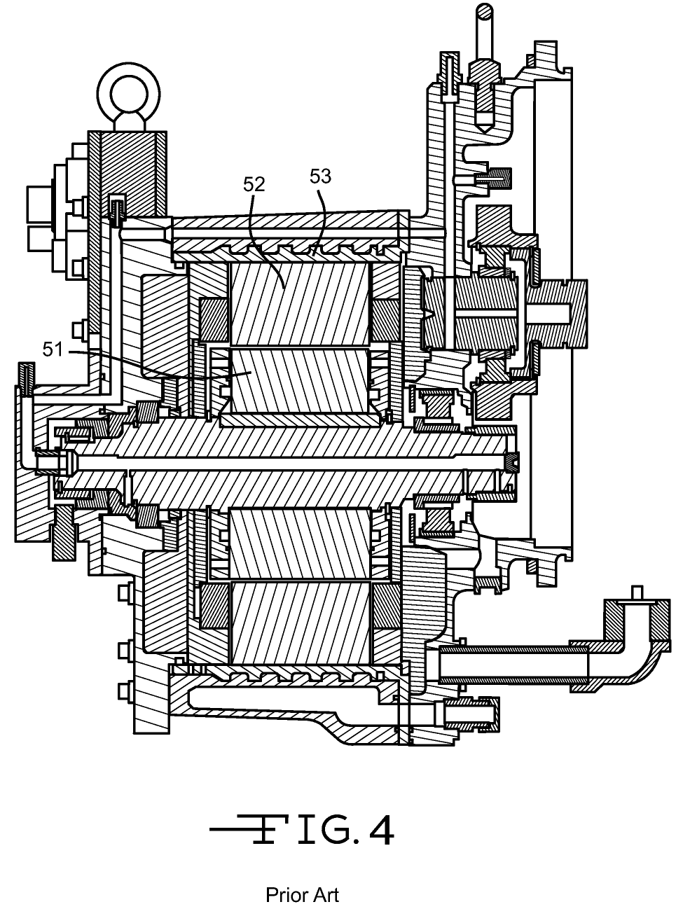

FIG. 5A is a cross-sectional side perspective view of a switched reluctance machine according to the disclosure.

FIG. 5B is a magnified view of the dotted section of FIG. 5A.

FIG. 6 is an end-on view of an energized switched reluctance machine's flux lines.

Whenever possible, the same reference numbers will be used throughout the drawings to refer to the same or like parts.

### DETAILED DESCRIPTION

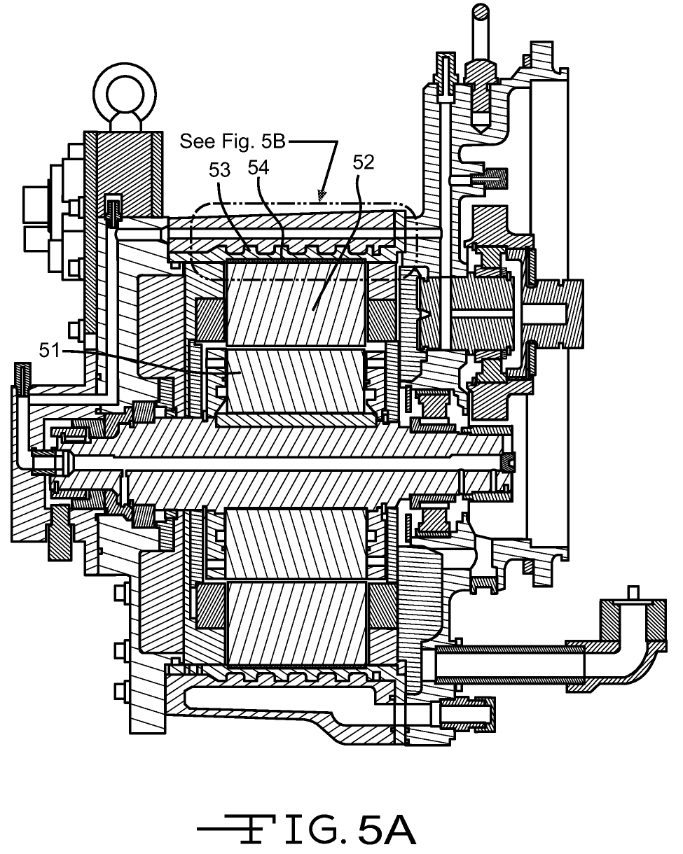

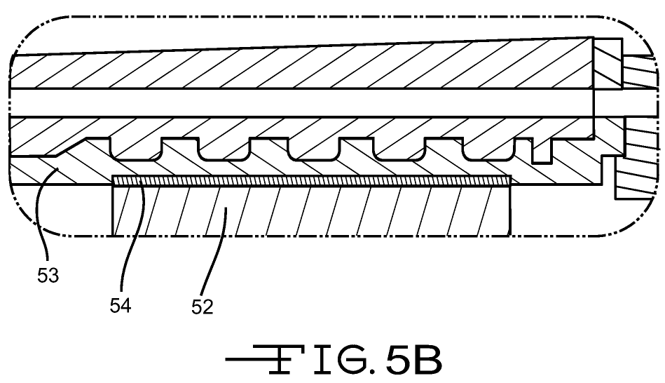

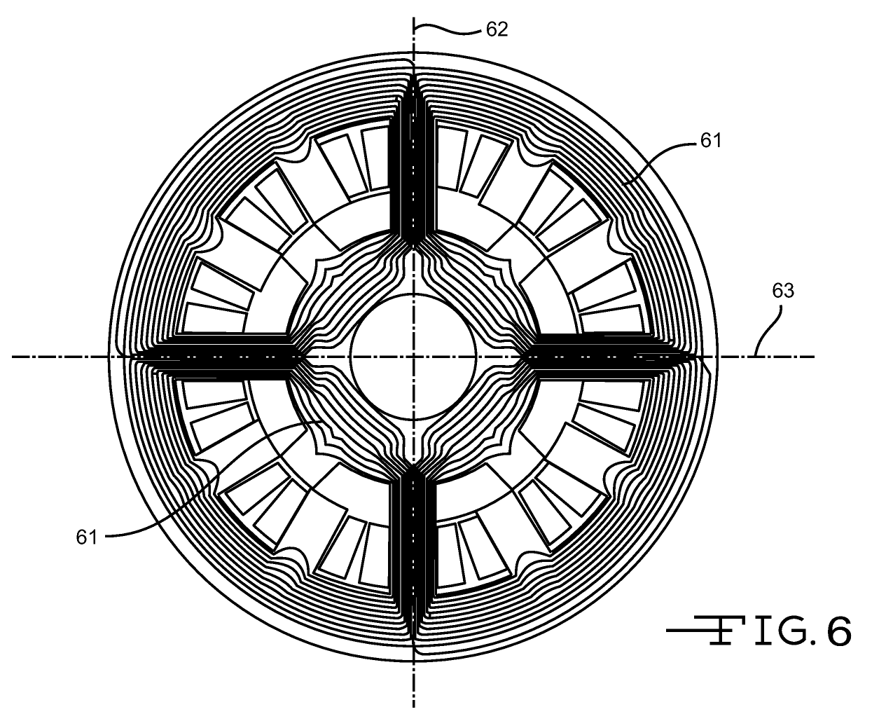

With reference to the drawings, FIG. 5A illustrates a cross-sectional area of a switched reluctance machine comprising a rotor 51, a stator 52, a housing 53, and a magnetic eddy current dampening component 54 disposed between stator 52 and housing 53. FIG. 5B shows a magnified view of the portion indicated in FIG. 5A, detailing the magnetic eddy current dampening component 54 disposed between stator 52 and housing 53. As the switched reluctance machine is operated according to conventional practice, magnetic fields are formed in the machine as a result of the various changes in current throughout the machine. For example, FIG. 6 is an end-on view of an energized switched reluctance machine, with magnetic fields 61 represented as lines depicting magnetic flux within the machine. In the embodiment shown in FIG. 6, stator poles 1,7 (shown as 62) and 4,10 (shown as 63) are energized, which would also cause flux lines to loop through the rotor poles 1,5 (corresponding to 62) and 3,7 (corresponding to 63).

In selecting an appropriate material for magnetic eddy current dampening component 54, considerations such as the magnetic permeability, electrical conductivity, yield strength, and coefficient of thermal expansion must be taken into account. Particularly, switched reluctance machines may be used in wide ranges of temperature during use, such as from about −20° C. to about 190° C., or even wider. More typical ranges may be from about 0° C. to about 160° C., but such a temperature range is still wide enough to induce stress on magnetic eddy current dampening component 54 or change the torque carrying capacity of magnetic eddy current dampening component 54.

With further reference to FIG. 6, magnetic flux lines are shown extending beyond the stator and into magnetic eddy current dampening component 54. The shielding component of the immediate disclosure is designed specifically to dissipate the magnetic flux outside of the stator, thereby increasing the efficiency of the switched reluctance machine. The considerations that must be taken into account when measuring the flux extending beyond magnetic eddy current dampening component 54 are the flux density (B), the strength of the eddy current (I), and the power loss considerations. Flux density is calculated as:

B=μ₀μᵣ*H

where
μ₀=permeability of free space
μᵣ=relative permeability of material
H=magnetic field strength

Moreover, the strength of the eddy current (I) is a function of the frequency of the switched reluctance machine (f), the flux density (B), and conductivity (1/ρ). Further, the power loss calculation is based on the fact that power loss is a function of the square of frequency (f²), the square of the flux density (B²), the conductivity (1/ρ), and the volume of the material. This relationship is based on the fact that there is more iron within the coil bundle of a switched reluctance machine rather than a traditional AC induction generator and the fact that there is a high frequency of current in a switched reluctance machine that creates large eddy currents. From this final consideration of power loss calculation, one would deduce that removing material volume is a straightforward way to reduce the power loss of the system, which would improve the efficiency of the switched reluctance machine. However, removing material from magnetic eddy current dampening component 54 is not always practically feasible.

Specific analysis of traditional cast iron and potential magnetic eddy current dampening component 54 materials, e.g., aluminum and stainless steel for eddy current strength and power loss demonstrates superior performance of both aluminum and stainless steel. Specifically, the power loss ratio of cast iron:aluminum:stainless steel is 90909:35.71:1.38. The relatively high value of power loss with cast iron material reflects the inefficiency of the traditional system. Moreover, the eddy current strength ratio of cast iron:aluminum:stainless steel is 909:35.71:1.38, which again demonstrates the superior ability of aluminum and stainless steel to reduce the strength of the eddy current compared to the traditional cast iron material selection.

Accordingly, to reduce the eddy current strength, magnetic eddy current dampening component 54 comprises a main body being generally cylindrical, having an inner surface, an outer surface, and a wall thickness between the inner surface and the outer surface. The specific thickness required is determined by the material used to form magnetic eddy current dampening component 54 and its properties. The two key material considerations from an electromagnetic perspective are permeability and resistivity.

The first property of interest is the relative magnetic permeability of magnetic eddy current dampening component 54. Magnetic permeability, as used herein, is a relative measure of a material's ability or propensity to allow an applied magnetic field to continue beyond the material. Effectively, a lower relative permeability is desired. In the present disclosure, the main body of magnetic eddy current dampening component 54 comprises a material having relative magnetic permeability of less than about 5, such as less than about 1.5. More particularly, a range of relative permeability desired is between about 0.5 and about 1.2. Such acceptable magnetic permeability might include magnetic permeability of less than about 25×10⁻⁷ H/m, such as between about 12.00×10⁻⁷ H/m and about 13.00×10⁻⁷ H/m.

Another important property of the material of magnetic eddy current dampening component 54 is resistivity. Resistivity is important because as the resistivity increases, so does the requisite skin depth of magnetic eddy current dampening component 54. The relationship can be shown as:

$$Skin Depth = 503 \sqrt{\frac{ρ}{{μ}_{r} f}} \qquad ( 1 )$$

where:
   μᵣ⁻=the relative permeability of the medium
   ρ=the resistivity of the medium in Ωm
   f=the frequency of the wave in Hz
      More specifically, the resistivity of the magnetic eddy current dampening component 54 material is less than about 1.0×10⁻⁶ Ω-m, such as less than about 7.5×10⁻⁷ Ω-m, less than about 2.5×10⁻⁷ Ω-m, or less than about 1.0×10⁻⁷ Ω-m.

Further, the ability of certain materials to dissipate the eddy currents over a certain thickness or depth, commonly referred to as skin depth, may be taken into account when selecting the appropriate material for eddy current dampening component 54. This analysis is based on the magnetic field magnitude, δ, and the corresponding current density, J, as follows:

Jₓ=Jₒe^{-x/δ}
where:
   Jₓ=current density at depth x
   Jₒ=current density at surface
      The strength of the eddy current at depth x below the surface of eddy current dampening component 54 is then proportional to:

(μᵣ/ρ)*e^{-x/δ}

After performing the appropriate calculations, the ratio for cast iron:aluminum:stainless steel at a given depth of 3.6 mm is 6.12:13.13:1.13. The corresponding ratio of eddy current power loss at a depth of 3.6 mm is 4.03:4.83:0.93.

In addition to the above electromagnetic considerations, several mechanical properties of the material used for magnetic eddy current dampening component 54 must be considered, as magnetic eddy current dampening component 54 is disposed between stator 52 and housing 53 and movement or slippage during use is deleterious to performance. Typically, the switched reluctance machine of the immediate disclosure is constructed by press fitting magnetic eddy current dampening component 54 on stator 52. If the press fit is compromised, there may be insufficient force applied between stator 52 and housing 53 to carry an applied torque. Accordingly, a primary consideration is the coefficient of thermal expansion (CTE) of the material, as the material will be cycled through temperatures in the range of 0° C. to 160° C. The CTE will ideally be as close to the CTE of stator 52 and housing 53 as possible. For example, the CTE of stator 52 is between about 1.7×10⁻⁵/° C. and about 1.8×10⁻⁵/° C., as stator 52 is commonly made of a silicon steel. Also, the CTE of housing 53 is between about 1.0×10⁻⁵/° C. and about 1.1×10⁻⁵/° C., as housing 53 is commonly made of cast iron. Accordingly, the CTE of the material of magnetic eddy current dampening component 54 is between about 1.00×10⁻⁵/° C. and about 2.5×10⁻⁵/° C., such as between about 1.20×10⁻⁵/° C. and about 1.70×10⁻⁵/° C. For reference, the CTE of aluminum is about 2.38×10⁻⁵/° C. and the CTE of some stainless steels is about 1.60×10⁻⁵/° C.

Another important mechanical property of the material used for magnetic eddy current dampening component 54 is the yield strength of the material. This is another important property for maintaining a press fit that can withstand the stress between stator 52 and magnetic eddy current dampening component 54 and to the interface between housing 53 and magnetic eddy current dampening component 54 at lower temperatures.

In one embodiment of the present disclosure, the material used for magnetic eddy current dampening component 54 is an aluminum alloy. Regarding the above properties, the magnetic permeability of viable aluminum alloys is between about 12.00×10⁻⁷ H/m and about 13.00×10⁻⁷ H/m, such as about 12.5×10⁻⁷ H/m. The resistivity of viable aluminum alloys is between about 2.5×10⁻⁸ Ω-m and about 3.0×10⁻⁸ Ω-m, such as about 2.8×10⁻⁸ Ω-m. The CTE of viable aluminum alloys is between about 2.2×10⁻⁵ and about 2.5×10⁻⁵. Finally, the yield strength of viable aluminum alloys is between about 125 N/mm² and about 135 N/mm².

In another embodiment of the present disclosure, the material used for magnetic eddy current dampening component 54 is a stainless steel alloy, such as A317 stainless steel. Regarding the above properties, the magnetic permeability of viable stainless steel alloys is between about 1.20×10⁻⁶ H/m and about 1.30×10⁻⁶ H/m, such as about 1.25×10⁻⁶ H/m. The resistivity of viable stainless steel alloys is between about 7.0×10⁻⁷ Ω-m and about 7.5×10⁻⁷ Ω-m, such as about 7.2×10⁻⁷ Ω-m. The CTE of viable stainless steel alloys is between about 1.5×10⁻⁵ and about 1.8×10⁻⁵. Finally, the yield strength of viable stainless steel alloys is between about 285 N/mm² and about 295 N/mm².

### INDUSTRIAL APPLICABILITY

Magnetic eddy current dampening component 54 addresses the pervasive problem of inefficiency in switched reluctance machines resulting from magnetic flux extending beyond the housing of the machine.

To manufacture the switched reluctance machine of this disclosure, a rotor and stator are combined in a typical fashion. Magnetic eddy current dampening component 54 is then slid over the stator and press fit onto the stator. A housing for the switched reluctance machine is then press fit onto magnetic eddy current dampening component 54.

Switched reluctance machines according to the present disclosure may be used in a variety of heavy machinery, trucks, or automobiles that rely on some form of electric power for propulsion. Examples include hybrid vehicles, both with and without energy storage capability, and fully electric powered vehicles.

Although the present inventions have been described with reference to exemplary embodiments, workers skilled in the art will recognize that changes may be made in form and detail without departing from the sprit and scope of the invention. For example, although different exemplary embodiments may have been described as including one or more features providing one or more benefits, it is contemplated that the described features may be interchanged with one another or alternatively be combined with one another in the described exemplary embodiments or in other alternative embodiments. Because the technology of the present invention is relatively complex, not all changes in the technology are foreseeable. The present invention described with reference to the exemplary embodiments and set forth in the flowing claims is manifestly intended to be as broad as possible. For example, unless specifically otherwise noted, the claims reciting a single particular element also encompass a plurality of such particular elements.

What is claimed is:

1. A magnetic eddy current dampening component for switched reluctance machines, the magnetic eddy current dampening component comprising a generally cylindrical main body having an inner surface, an outer surface, and a wall thickness between the inner surface and the outer surface,
wherein the main body comprises a material having relative magnetic permeability of less than about 5 and a coefficient of thermal expansion at room temperature of between about 1.00×10⁻⁵/° C. and about 2.50×10⁻⁵/° C.

2. The magnetic eddy current dampening component of claim 1, wherein the relative magnetic permeability of the main body is between about 0.5 and about 1.2.

3. The magnetic eddy current dampening component of claim 1, wherein the resistivity of the main body is less than about 1.0×10⁻⁶ Ω-m.

4. The magnetic eddy current dampening component of claim 1, wherein the magnetic permeability of the main body is between about 1.20×10⁻⁶ H/m and about 1.30×10⁻⁶ H/m.

5. The magnetic eddy current dampening component of claim 4, wherein the main body is formed from a stainless steel.

6. The magnetic eddy current dampening component of claim 5, wherein the main body is formed from A317 stainless steel.

7. The magnetic eddy current dampening component of claim 5, wherein the resistivity of the main body is between about 7.0×10⁻⁷ Ω-m and about 7.5×10⁻⁷ Ω-m.

8. The magnetic eddy current dampening component of claim 5, wherein the coefficient of thermal expansion of the main body is between about 1.5×10⁻⁵/° C. and about 1.8×10⁻⁵/° C.

9. The magnetic eddy current dampening component of claim 5, wherein the yield strength of the main body is between about 285 N/mm² and about 295 N/mm².

10. The magnetic eddy current dampening component of claim 4, wherein the main body is formed from an aluminum alloy.

11. The magnetic eddy current dampening component of claim 10, wherein the resistivity of the main body is between about 2.5×10⁻⁸ Ω-m and about 3.0×10⁻⁸ Ω-m.

12. The magnetic eddy current dampening component of claim 10, wherein the coefficient of thermal expansion of the main body is between about 2.2×10⁻⁵/° C. and about 2.5×10⁻⁵/° C.

13. The magnetic eddy current dampening component of claim 9, wherein the yield strength of the main body is between about 125 N/mm² and about 135 N/mm².

14. A switched reluctance machine comprising:
a rotor
a stator
a housing
a magnetic eddy current dampening component disposed between the stator and the housing, wherein the magnetic eddy current dampening component comprises a main body being generally cylindrical, having an inner surface, an outer surface, and a wall thickness between the inner surface and the outer surface, wherein the main body comprises a material having relative magnetic permeability of less than about 5 and a coefficient of thermal expansion at room temperature of between about 1.00×10⁻⁵/° C. and about 2.50×10⁻⁵/° C.

15. The switched reluctance machine of claim 14, wherein the housing is formed from a magnetic material.

16. The switched reluctance machine of claim 14, wherein the main body is formed from a stainless steel.

17. The switched reluctance machine of claim 16, wherein the main body is formed from A317 stainless steel.

18. The switched reluctance machine of claim 16, wherein the resistivity of the main body is between about 7.0×10⁻⁷ Ω-m and about 7.5×10⁻⁷ Ω-m.

19. The switched reluctance machine of claim 16, wherein the coefficient of thermal expansion of the main body is between about 1.5×10⁻⁵/° C. and about 1.8×10⁻⁵/° C.

20. The switched reluctance machine of claim 16, wherein the yield strength of the main body is between about 285 N/mm² and about 295 N/mm².
